(19) United States
(12) Patent Application Publication
(10) Pub. No.: US 2008/0235981 A1
(43) Pub. Date: Oct. 2, 2008

(54) METHOD AND APPARATUS FOR DRYING FILM AND SOLUTION CASTING METHOD

(75) Inventors: Moritaka KATO, Kanagawa (JP); Toshikazu NAKAMURA, Kanagawa (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/054,407

(22) Filed: Mar. 25, 2008

(30) Foreign Application Priority Data
Mar. 29, 2007 (JP) 2007-089608

(51) Int. Cl. F26B 7/00; B29D 7/01; F26B 19/00; F26B 25/00

(52) U.S. Cl. 34/427; 34/459; 264/212; 34/85; 34/646

(57) ABSTRACT

In a pin tenter, a wet film is conveyed and dried in a state that edges of the wet film are pierced by pins. The plurality of pins are fixed to a pin plate. The pin plate is supported by a pin carrier. The pin carrier is disposed between rails. Movement of the pin carrier is guided by the rails. Nitrogen gas is supplied through a nozzle to the inside of a rail cover in a gas purge area, and thus the inside of the rail cover is pressurized. Atmospheric gas containing solvent gas in the pin tenter is prevented from entering the inside of the rail cover. Accordingly, precipitation of additives and the like on the rails and the pin carrier is eliminated. A suction device sucks nitrogen gas together with foreign substances such as dust from the inside of the pressurized rail cover.

### FIELD OF THE INVENTION

The present invention relates to a method and an apparatus for drying a film while the film is conveyed in a state that both side edge portions of the film are held, and a solution casting method to which a method and an apparatus for drying the film are introduced.

### BACKGROUND OF THE INVENTION

Polymer films have excellent optical transparency and flexibility, and are formed into thin and lightweight films. Therefore, the polymer films are used as optical functional films for various uses. In particular, cellulose ester films produced from cellulose acylate and the like have strength and low birefringence in addition to the above properties. The cellulose ester films are used as protection films for polarizing filters and optical compensation films which constitute liquid crystal displays (LCDs), whose market is expanding, as well as photosensitive films.

A solution casting method is one of production methods for polymer films. According to the solution casting method, a dope containing a polymer and a solvent is cast from a casting die onto a support and a casting film is formed. After the casting film obtains a self-supporting property, the casting film is peeled from the support as a wet film. The wet film is conveyed through a tenter while both side edge portions (hereinafter referred to as edges) of the wet film are held. In the tenter, the wet film is dried while being conveyed. Thus, a film is produced. After the edges of the film are cut, the film is further dried in a drying device. Thereafter, the film is wound by a winding device.

The wet film is dried in the tenter in a state that the film is conveyed while the edges of the film are held by holding members such as clips or pins and dry air is blown onto the film. The holding members are fixed to an endless loop moving section such as a chain and circulated. Therefore, the temperature of the holding members increases in the proximity of an outlet of the tenter after the holding members are exposed to dry air at high temperature. If the incoming film is held by the holding members of high-temperature, a solvent contained the film comes to a boil and foam is generated. As a result, the film may be torn. In a solution casting method by which the film is cooled and gelated to obtain a self-supporting property, the film is held using pin plates. If the temperature of the pins is high, resin (polymer) contained in the film is solidified into powder by the heat of the pins and covers over the pins like a cap when the pins pierce the film. The cap-like powder is peeled off and causes failures in the tenter and scratches on the film. To prevent such problems, the holding members are cooled by passing them through a cooling duct before holding the both edges of the incoming film (see, for example, Japanese Patent Laid-Open Publication No. 9-85846).

However, the cooling duct has raised new problems. The tenter is filled with solvent vapors evaporated from the wet film. In a high temperature atmosphere inside the tenter, plasticizers and UV absorbents contained in the wet film are also evaporated together with solvents, and such vapors are included in the solvent vapors. The solvent vapors enter the cooling duct in association with movements of clips or pins. The solvent vapors are cooled in the cooling duct and liquefied or solidified. Such liquefied or solidified solvents adhere to the pins and pin plates as foreign substances. The foreign substances contain a large amount of additives such as plasticizers and UV absorbents. Loads on the pin plates increase as the amount of the foreign substances increase. When the foreign substances are accumulated on guide rollers used for conveying the film, and bearings used in the guide rollers, the film is not stably conveyed.

To solve the above problems, the following measures may be taken: plasticizers and UV absorbents resistant to gasification may be used; drying temperature of the tenter may be lowered; drying time in the tenter may be increased; and the like. However, new problems may arise as a result of the above changes. For example, the above changes may affect the quality of the produced film and increase production costs. On the other hand, it is also possible to use a brush or the like to remove the foreign substances adhered to the pin plates. However, such brush may be clogged and/or the foreign substances on the brush may adhere to the pin plates again, and the pin plates may have areas where the brush cannot reach.

In the tenter, solvents are recovered from the solvent vapors by condensation and adsorption. The gas from which solvents have been removed is sent to the tenter and reused. During the recovery of the solvents, plasticizers and UV absorbents are also recovered However, an amount of the foreign substances adhered to the guide rollers and the like cannot be reduced to zero.

It may be possible to clean the pin plates and the like with the use of a cleaning solvent. However, such cleaning solvent has weak cleaning effect and may dissolve oil components of a lubricant applied to the conveyor guide rollers and bearings. If the cleaning solvent is evaporated in the tenter, it is also necessary to recover the cleaning solvent from the solvent vapors Therefore, it has been necessary to stop the film production line at regular time intervals and clean the guide rollers and the like off-line.

### SUMMARY OF THE INVENTION

In view of the foregoing, an object of the present invention is to provide a method and an apparatus for drying a film and a solution casting method, capable of stabilizing conveyance of the film by removing foreign substances which obstruct the film conveyance.

In order to achieve the above and other objects, a film drying method according to the present invention has a drying step and a gas purge step. In the drying step, the film is dried by blowing dry air onto the film while being conveyed by a pair of endless loop moving sections in a state that side edge portions of the film are held by holding members. Each of the endless loop moving sections is provided with a carrier body having the holding members arranged at predetermined intervals. In the gas purge step, inert gas is supplied to and purged from a duct. The duct covers the carrier body in an area where the film is held by the holding members. A supply position and a recovery position of the inert gas on the duct are in the proximity of a film release position where the film is released from the holding members.

It is preferable that the film drying method has a steam cleaning step. In the steam cleaning step, it is preferable that the holding members and the carrier body are cleaned by blowing steam onto the holding members and the carrier body after the film is released from the holding members. It is preferable that the film drying method further includes a gas-blow cleaning step after the steam cleaning step. In the gas-blow cleaning step, it is preferable that the holding members and the carrier body are cleaned by blowing gas onto the holding members and the carrier body after the film is released from the holding members.

A solution casting method according to the present invention has the following steps: forming a casting film by casting a dope containing a polymer and a solvent onto a continuously moving support; peeling the casting film from the support as a wet film; drying the wet film by blowing dry air onto the wet film while the wet film is conveyed using a pair of endless loop moving sections in a state that side edge portions of the wet film are held by holding members, and each of the endless loop moving sections is provided with a carrier body having the holding members arranged at predetermined intervals; and supplying inert gas to a duct and purging the inert gas from the duct. The duct covers the carrier body in an area where the film is held by the holding members.

A film drying apparatus according to the present invention has a pair of endless loop moving sections for conveying the film, a drying section, and a gas purge section. Each of the endless loop moving sections includes the holding members for holding side edge portions of the film and the carrier body on which the holding members are arranged at predetermined intervals. In the drying section, the film is dried by blowing dry air onto the film which is conveyed while being held by the holding members. In the gas purge section, the inert gas is supplied to and purged from a duct. The duct covers the carrier body in the area where the film is held by the holding members.

It is preferable that the gas purge section includes an inert gas supplying section and an inert gas circulating section. The inert gas supplying section supplies inert gas to the duct and purges the inert gas from the duct. The inert gas circulating section recovers the inert gas from the duct and feeds the recovered inert gas to the inert gas supplying section. The duct is kept in a pressurized state by the inert gas supplying section.

It is preferable that the supply position and the recovery position of the inert gas on the duct are located immediately after the film release position where the film is released from the holding members.

It is preferable that the film drying apparatus further includes a steam cleaning section. In the steam cleaning section, it is preferable that the holding members and the carrier body are cleaned by blowing steam onto the holding members and the carrier body. It is preferable that the film drying apparatus further includes a gas-blow cleaning section provided downstream from the steam cleaning section with respect to a moving direction of the carrier body. In the gas-blow cleaning section, it is preferable that the holding members and the carrier body are cleaned by blowing gas onto the holding members and the carrier body after the film is released from the holding members.

According to the present invention, foreign substances which obstruct the film conveyance are removed, and thus the film is conveyed with stability.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view of a film producing line;

FIG. 2 is a plane view of a pin tenter of the present invention;

FIG. 3 is a front view of the pin tenter of the present invention;

FIG. 4 is a sectional view of a rail, rail cover, and a pin carrier;

FIG. 5 is a sectional view of the rail, the rail cover, and the pin carrier in a state that a tooth of sprocket fits in a groove of the pin carrier;

FIG. 6 is a sectional view of the rail, the rail cover, and the pin carrier in a gas purge area, taken along a line VI-VI in FIG. 3;

FIG. 7 is a sectional view of the rail, the rail cover, and the pin carrier in a steam cleaning area, taken along a line VII-VII in FIG. 3;

FIG. 8 is a sectional view of the rail, the rail cover, and the pin carrier in a jet gas cleaning area, taken along a line VIII-VIII in FIG. 3;

FIG. 9 is a sectional view of the rail, the rail cover, and the pin carrier in a first cooling area, taken along a line IX-IX in FIG. 3; and

FIG. 10 is a sectional view of the rail, the rail cover, and the pin carrier in a dry ice cleaning area, taken along a line X-X in FIG. 3.

### DETAILED DESCRIPTION OF THE PREFERRED EMBODIMENTS

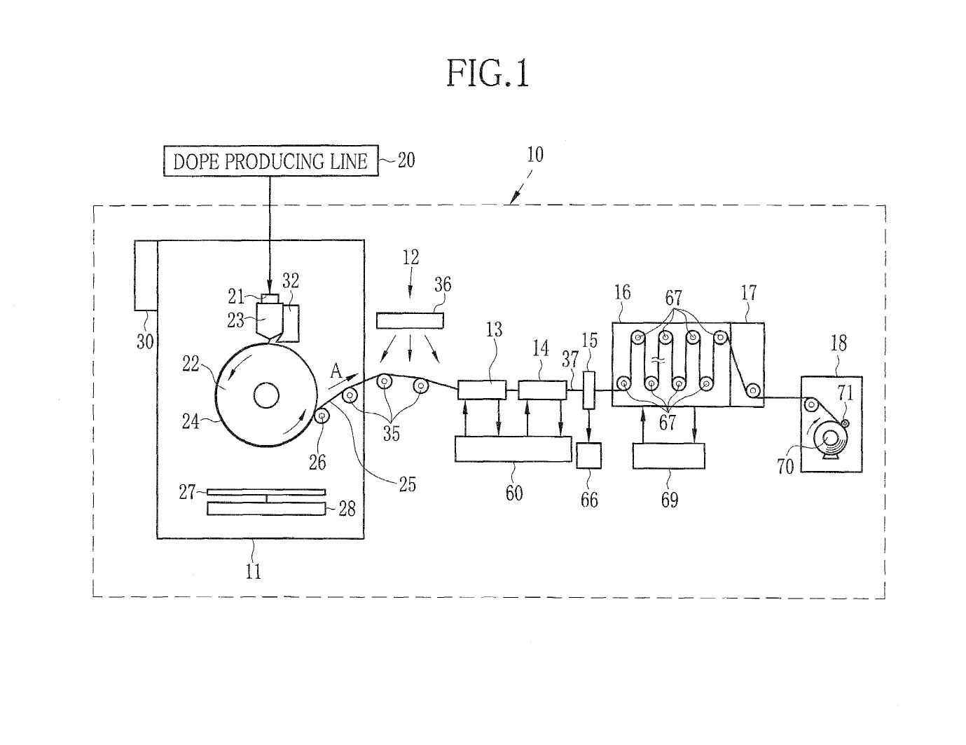

As shown in FIG. 1, a film producing line 10 is constituted of a casting chamber 11, a -transfer section 12, a pin tenter 13, a clip tenter 14, an edge slitting device 15, a drying device 16, a cooling device 17, and a winding device 18.

The casting chamber 11 is provided with a feed block 21, a drum 22, a casting die 23, a peel roller 26, a condenser 27, and a recovery device 28. A dope is fed from a dope producing line 20 to the feed block 21. The dope is cast onto the drum 22, which is a support, through the casting die 23. A casting film 24 formed on the drum 22 is peeled as a wet film 25 using the peel roller 26. The condenser 27 condenses and liquefies solvent vapors evaporated from the casting film 24 and the wet film 25. The liquefied solvent is recovered by the recovery device 28. A heat transfer medium supplying device (not shown) is connected to the drum 22. The heat transfer medium supplying device supplies a heat transfer medium to the inside of the drum 22 so that a surface temperature of the drum 22 is adjusted at a predetermined value. A temperature controller 30 is attached to the casting chamber 11 to adjust the inner temperature of the casting chamber 11.

Inside the feed block 21, a flow path of the dope is formed. A decompression chamber 32 is attached to the casting die 23. The decompression chamber 32 reduces pressure in an area upstream from a bead with respect to a rotating direction of the drum 22 to stabilize the contact of the bead to the drum 22. The bead is a dope between a discharge port of the casting die 23 and the drum 22. A jacket (not shown) is attached to the decompression chamber 32 so as to adjust the temperature of the decompression chamber 32 at a predetermined value.

The drum 22 is a stainless steel drum capable of being continuously rotated. The surface of the drum 22 is polished. Thereby, the casting film 24 with excellent planarity is formed on the drum 22. In this embodiment, the drum 22 is used as the support. However, the support is not particularly limited. For example, an endless casting belt looped around a pair of rollers and moved continuously may be used as a support. It is preferable that a width of the support is 1.1 times to 2.0 times larger than a casting width of the dope. It is preferable that the material of the support has corrosion-resistance and high strength, for example, stainless steel.

Shapes, materials, dimensions of the casting die 23 are not particularly limited. However, it is preferable to use a casting die of a coat hanger type, which keeps a casting width of the dope approximately uniform. It is preferable that a width of the discharge port of the casting die 23 is 1.1 times to 2.0 times larger than a casting width of the dope. In view of durability and heat resistance, it is preferable that the material of the casting die 23 is precipitation hardened stainless steel and has anti-corrosion properties which do not form pitting (holes) on the gas-liquid interface after having been dipped in a liquid mixture of dichloromethane, methanol and water for three months. Materials which have the almost same anti-corrosion properties as SUS316 in examination of corrosion in electrolyte solution may also be suitable. In view of heat resistance, it is preferable to use materials having coefficient of thermal expansion of at most 2×10⁻⁵ (° C.⁻¹).

Further, it is more preferable that the lip ends of the discharge port of the casting die 23 are provided with a hardened layer to improve abrasion resistance. Forming methods of the hardened layer are not particularly limited. For example, ceramics coating, hard chrome plating, nitriding treatment and the like may be used. When ceramics are used as the hardened layer, it is preferable that the ceramics are grindable but not friable, and have a lower porosity and the good corrosion resistance. It is also preferable that the ceramics have high adhesion to the casting die but low adhesion to the dope. Specifically, tungsten carbide (WC), Al₂O₃, TiN, Cr₂O₃ and the like may be used, and WC is especially preferable. A WC coating may be performed by well-known spraying methods.

A plurality of rollers 35 are installed in the transfer section 12. The rollers 35 convey the wet film 25 peeled off from the drum 22 to the pin tenter 13. Hereinafter, a conveying direction of the wet film 25 is referred to as direction A. An air blower 36 is provided above the conveying path of the wet film 25. The air blower 36 blows dry air onto the wet film 25 to advance the drying of the wet film 25.

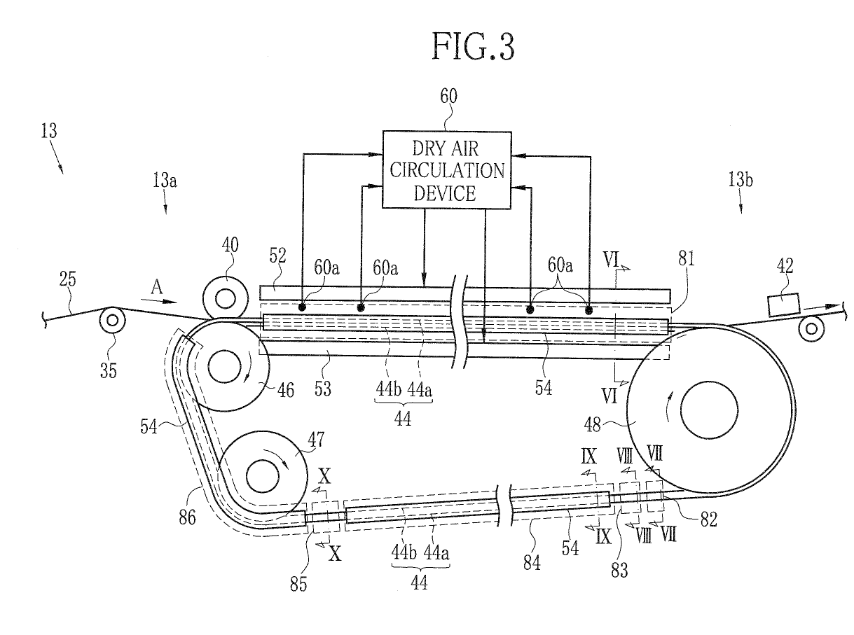

In the pin tenter 13, both side edge portions (hereinafter referred to as edges) of the wet film 25 are pierced and held by the pins and the wet film 25 is conveyed while being held by the pins. The pin tenter 13 will be detailed later. Dry air is blown onto the wet film 25 through dry air ducts 52 and 53 (see FIG. 3) and the wet film 25 is heated to a predetermined temperature, and thus the drying of the wet film 25 is advanced. Then, the dry air is sent to a dry air circulation device 60 (see FIG. 3) through a vent 60a (see FIG. 3). The dry air circulation device 60 adsorbs and recovers solvents and plasticizers from the dry air, and then feeds the recovered dry air to the dry air ducts 52 and 53 after the adsorption.

The clip tenter 14 is provided downstream from the pin tenter 13. In the clip tenter 14, the wet film 25 is conveyed and dried while the edges of the wet film 25 are held. Dry air ducts (not shown) are disposed on each of a top area and a bottom area inside the clip tenter 14 such that the wet film 25 is interposed between the dry air ducts. The wet film 25 is dried using the dry air ducts. Thus, a film 37 is produced. The clip tenter 14 may be used as necessary. It is also possible to omit the clip tenter 14. In this case, the film 37 is sent from the pin tenter 13 to the drying device 16.

The film 37 is sent from the clip tenter 14 to the edge slitting device 15. The edge slitting device 15 cuts off the edges of the film 37. A crusher 66 is connected to the edge slitting device 15. The crusher 66 crushes the cut-off edges of the film 37 into chips. Thereafter, the film 37 is sent to the drying device 16. A plurality of rollers 67 are provided inside the drying device 16. The film 37 is dried while being conveyed by the rollers 67. Solvent gas evaporated from the film 37 in the drying device 16 is adsorbed and recovered by a recovery device 69 disposed outside the drying device 16. After the solvent components are removed from the solvent gas by adsorption, the gas is sent to the drying device 16. The film 37 is sent from the drying device 16 to the cooling device 17. In the cooling device 17, the film 37 is cooled to approximate room temperature. The edge slitting device may also be disposed at the exit of the pin tenter 13. In this case, the film 37 is sent to the clip tenter after the edges are cut by the edge slitting device.

The film 37 is sent from the cooling device 17 to the winding device 18 having a winding shaft 70. The film 37 is wound in a roll form around the winding shaft 70. The winding device 18 has a press roller 71. The press roller 71 winds the film 37 while adjusting a winding pressure.

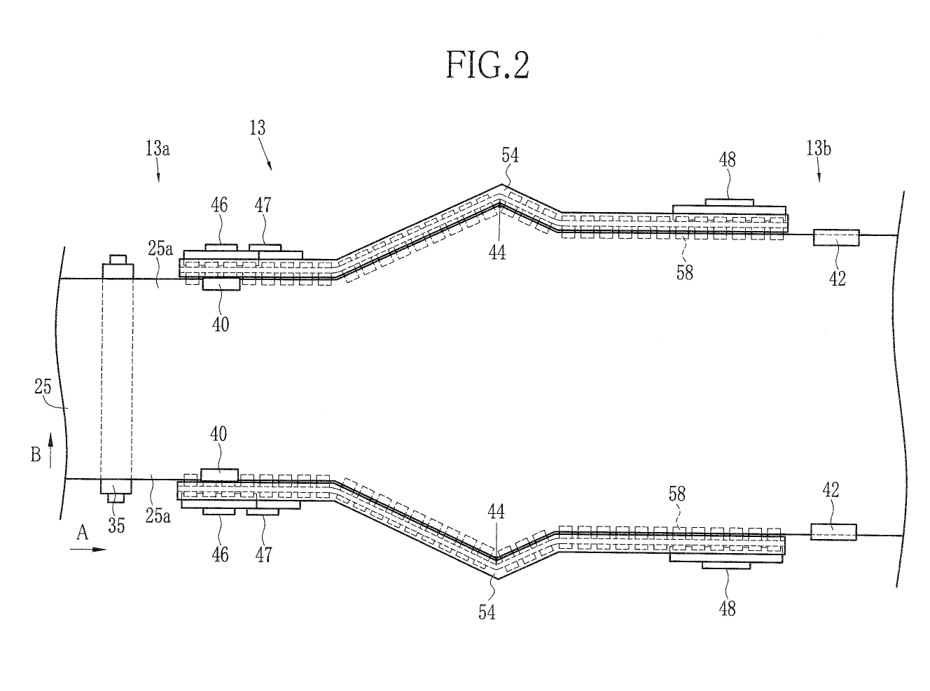

As shown in FIGS. 2 and 3, the pin tenter 13 conveys the wet film 25 in the direction A in a state that edges 25a of the wet film 25 are held. At the same time, the pin tenter 13 stretches the wet film 25 at a predetermined stretch ratio in a width direction (hereinafter referred to as direction B).

The pin tenter 13 is provided with brush rollers 40, dust collectors 42, rails 44, sprockets (return path members) 46 to 48, dry air ducts 52 and 53, rail covers (ducts) 54, and pin carriers (endless loop moving section) 58. The sprockets 46 to 48 determine the returning path of the pin carriers 58.

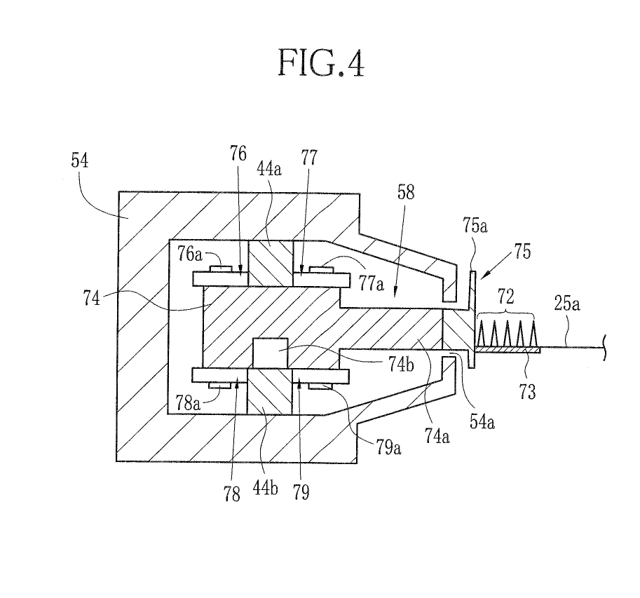

The brush rollers 40 are disposed in the proximity of an inlet 13a of the pin tenter 13. The brush rollers 40 are used for piercing pins 72 (see FIG. 4) through the edges 25a of the wet film 25 which entered the pin tenter 13. The dust collectors 42 are disposed in the proximity of an outlet 13b of the pin tenter 13 and remove dust from the edges 25a by suction.

The rail 44 is disposed on each side of a conveying path of the wet film 25. A distance between the rails 44 and widening of the distance between rails 44 (widening pattern) are determined in accordance with a stretch ratio of the wet film 25. The stretch condition depicted in FIG. 2 is exaggerated to a certain extent. FIG. 2 shows an example of the widening pattern. The widening pattern may be adopted in consideration of optical properties of the film. Each rail 44 is constituted of a pair of rails 44a and 44b disposed up and down.

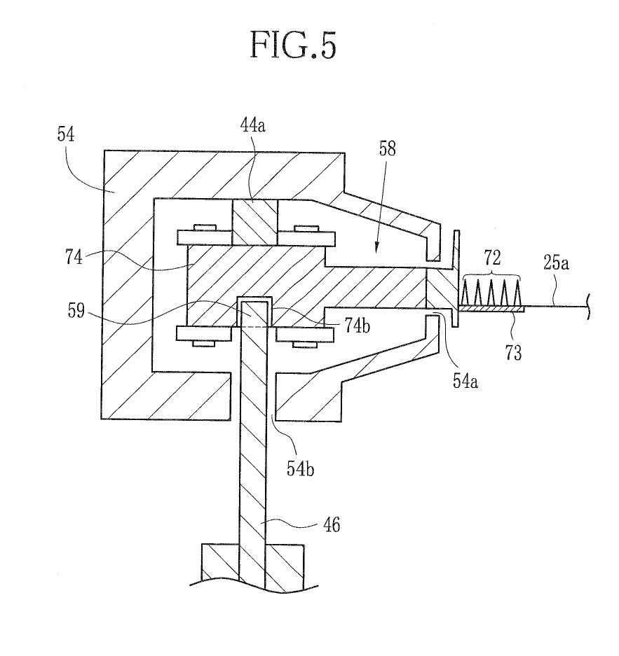

The sprockets 46 and 47 are disposed in the proximity of the inlet 13a of the pin tenter 13. The sprocket 48 is disposed in the proximity of the outlet 13b of the pin tenter 13. A tooth 59 (see FIG. 5) of the sprocket 46 fits in a fitting groove 74b (see FIG. 5) of the pin carrier 58. In the same manner, teeth (not shown) of the sprockets 47 and 48 fit in the fitting grooves 74b of the pin carrier 58. The pin carriers 58 are coupled to each other on the rail 44. In accordance with the rotation of the sprocket 48 driven by a motor (not shown), the pin carriers 58 are moved along the rail 44. The sprockets 46 and 47 are rotated along with the movements of the pin carriers 58.

The dry air duct 52 is disposed above and along the conveying path of the wet film 25. The dry air duct 53 is disposed below and along the conveying path of the wet film 25. The dry air duct 52 blows dry air onto an upper surface of the wet film 25. The dry air duct 53 blows dry air onto an undersurface of the wet film 25. The dry air blown from the dry air duct 52 and 53 is set at a predetermined temperature in a range of not less than 40° C. and not more than 200° C. Thereby, drying of the wet film 25 is advanced and solvent vapors are evaporated from the wet film 25.

As shown in FIG. 4, the rail cover 54 covers the rails 44a and 44b, and a part of the pin carriers 58. Inside the rail cover 54, the rail 44a is attached to the top inner surface and the rail 44b is attached to the bottom inner surface. The pin carrier 58 is disposed between the rails 44a and 44b. A slit 54a is formed on one side of the rail cover 54 along a moving direction of the pin carrier 58. The slit 54a is covered by a shielding member 75 to prevent inert gas and cooling gas fed to the inside of the rail cover 54 from escaping. The shielding member 75 will be detailed later. As shown in FIG. 5, each rail cover 54 located in the proximity of the sprocket 46 is formed with the slit 54b. The sprocket 46 enters the slit 54b. This is the same for the rail cover 54 located in the proximity of the sprocket 47 so that the description thereof is omitted.

As shown in FIG. 4, the pin carrier 58 is constituted of the pins 72, a pin plate 73, a carrier body 74, the shielding member 75, and guide rollers 76 to 79.

Each pin plate 73 has a plurality of pins 72 placed at predetermined intervals. The pin plate 73 is fixed to a shielding section 75a of the shielding member 75. A projection 74a is formed on the side of the carrier body 74 and supports the shielding member 75. The shielding member 75 is fixed to the projection 74a. In a center portion of an undersurface of the carrier body 74, the fitting groove 74b (see FIG. 5) is formed. The fitting groove 74b fits into the teeth of sprockets 46, 47, and 48.

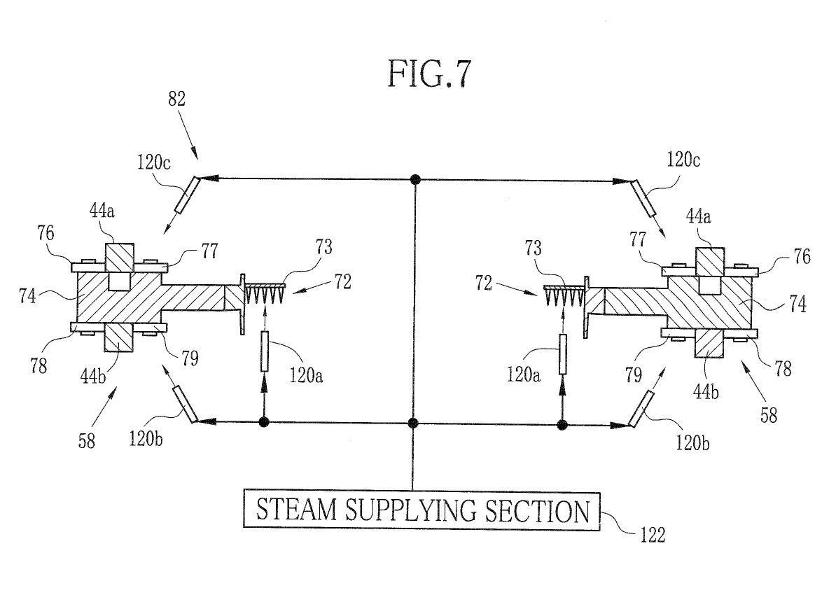

The shielding member 75 is fixed to the projection 74a of the carrier body 74 through the slit 54a of the rail cover 54. The shielding member 75 has the shielding section 75a which extends in vertical and horizontal directions and covers over the slit 54a of the rail cover 54. The shielding section 75a prevents dry air which contains solvent vapors evaporated from the wet film 25 from entering the inside of the rail cover 54. In addition, the shielding section 75a also prevents steam from entering the inside of the rail cover 54 when the pins 72 and the pin plates 73 are steam-cleaned in a steam cleaning area 82 (see FIG. 7). The steam cleaning area 82 will be detailed later.

The guide rollers 76 and 77 are disposed on a top surface of the carrier body 74 at a distance of the rail 44a apart. In the same manner, the guide rollers 78 and 79 are disposed on an undersurface of the carrier body 74, at a distance of the rail 44b apart. The guide rollers 76 and 77 nip the rail 44a. The guide rollers 78 and 79 nip the rail 44b. The guide rollers 76 to 79 guide the carrier body 74 when the carrier body 74 moves along the rails 44a and 44b.

A coupling bracket (not shown) is attached to a front end and a rear end of each carrier body 74 with respect to the moving direction of the carrier body 74. A coupling pin (not shown) is attached to each coupling bracket in the horizontal direction. The carrier bodies 74 are coupled through the coupling pins, which enable the carrier bodies 74 to move in the vertical direction as shown in FIG. 3. Instead of using the coupling brackets and the coupling pins to couple the block-shaped carrier bodies, chains may be used to configure pin carriers.

As shown in FIG. 3, the pin tenter 13 is provided with a gas purge area 81, the steam cleaning area 82, a jet gas cleaning area 83, a first cooling area 84, a dry ice cleaning area 85, and a second cooling area 86 along the moving direction of the pin carrier 58. Most of foreign substances which are removed by cleaning in the steam cleaning area 82, the jet gas cleaning area 83, and the dry ice cleaning area 85 are components contained in the solvent vapors evaporated from the wet film 25, specifically, liquefied or solidified additives of the dope. The additives are plasticizers such as TPP (triphenylphosphate), benzotriazol UV absorbents, and the like. The foreign substances also contain liquefied or solidified optical property controllers.

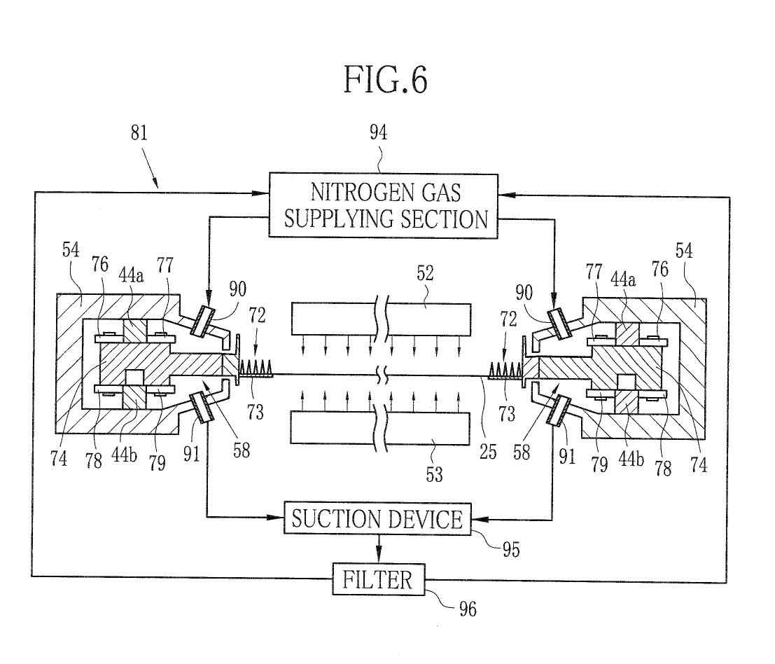

As shown in FIG. 6, in the gas purge area 81, a nozzle 90 for supplying gas and a vent pipe 91 for sucking gas are connected to the rail cover 54. An outlet of the nozzle 90 and an inlet of the vent pipe 91 are directed to the inside of the rail cover 54. The gas purge area 81 is provided with a nitrogen gas supplying section 94, a suction device 95, and a filter 96. The nitrogen gas supplying section 94 is connected to the nozzle 90. The suction device 95 is connected to the vent pipe 91. The suction device 95 is connected to the nitrogen gas supplying section 94 through the filter 96.

To perform the gas purge, nitrogen gas is supplied from the nitrogen gas supplying section 94 to the nozzle 90. Nitrogen gas is supplied to the inside of the rail cover 54 through the outlet of the nozzle 90. A pressure inside the rail cover 54 increases as the nitrogen gas is blown through the nozzle 90. At the same time, foreign substances adhered to the carrier body 74, the guide rollers 76 to 79, and the rails 44a and 44b are blown off and removed by the nitrogen gas. The suction device 95 sucks nitrogen gas and accumulated foreign substances from the inside of the pressurized rail cover 54 through the inlet of the vent pipe 91. The filter 96 removes the foreign substances from the nitrogen gas sucked by the suction device 95. Thereafter, the nitrogen gas is sent to the nitrogen gas supplying section 94.

In the gas purge area 81 of the pin tenter 13, concentration of the solvent vapors becomes especially high in an area where the edges 25a of the wet film 25 are released from the pins 72. In order to prevent the solvent vapors from entering the inside of the rail cover 54, the pressure inside the rail cover 54 is increased by supplying the nitrogen gas thereto. Even if the solvent vapors enter the inside of the rail cover 54 and liquefied or solidified and adhered to the guide rollers 76 to 79 as foreign substances, such foreign substances are removed by blowing the nitrogen gas. The removed foreign substances are discharged from the rail cover 54 using the suction device 95. Thus, foreign substances which hinder the movement of the pin carrier 58 are removed. As a result, the pin carrier 58 stably moves along the rail 44.

The gas purge is not limited to an area in which the wet film 25 is conveyed. The gas purge may be performed throughout the area in which the pin carrier 58 is moved. In this embodiment, the nozzle 90 and the vent pipe 91 are placed opposite sides of the rail cover 54. It is also possible to place the vent pipe 91 apart from the nozzle 90 with respect to the moving direction of the pin carrier 58. By placing the nozzle 90 and the vent pipe 91 apart, the pressure inside the rail cover 54 is effectively set higher than that inside the tenter 13. The gas purge area 81 may be provided with plural nozzles 90 and vent pipes 91 placed at predetermined intervals with respect to the moving direction of the pin carrier 58.

As shown in FIG. 7, nozzles 120a to 120c are provided in the steam cleaning area 82. The nozzles 120a to 120c are used for blowing steam. An outlet of the nozzle 120a is directed toward the pins 72 and the pin plate 73. The outlets of the nozzles 120b and 120c are directed toward the rails 44a and 44b, the carrier body 74, and the guide rollers 76 to 79. The steam cleaning area 82 is provided with a steam supplying section 122. The steam supplying section 122 is connected to the nozzles 120a to 120c.

To perform the steam cleaning, steam is supplied from the steam supplying section 122 to the nozzles 120a to 120c. The steam is blown from the outlet of the nozzle 120a onto the pins 72 and the pin plate 73. The steam is blown from the outlets of the nozzles 120b and 120c onto the rails 44a and 44b, the carrier body 74, and the guide rollers 76 to 79. Thereby, foreign substances adhered to the pins 72, the pin plate 73, the rails 44a and 44b, the carrier body 74, and the guide rollers 76 to 79 are removed. Removal of the foreign substances is not limited to the use of steam. Vapors of a liquid which effectively removes foreign substances may be used.

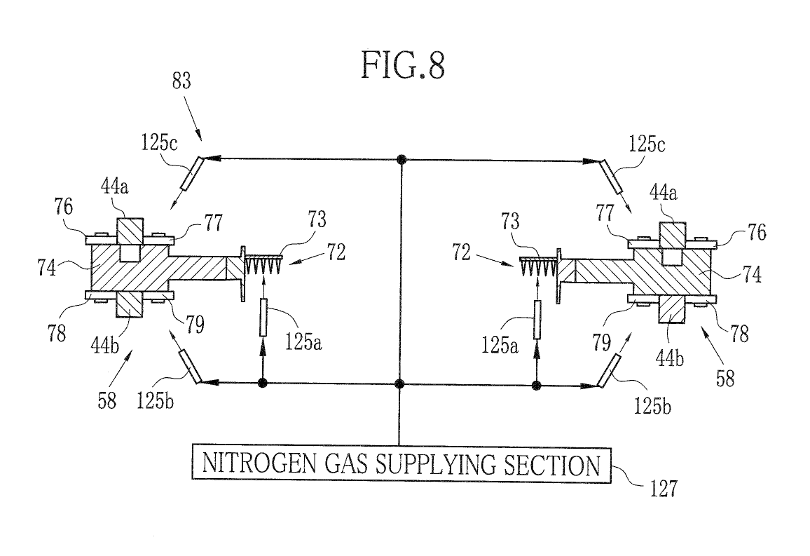

As shown in FIG. 8, nozzles 125a to 125c for blowing jet gas are provided in the jet gas cleaning area 83. Here, nitrogen gas is used as the jet gas. An outlet of the nozzle 125a is directed toward the pins 72 and the pin plate 73. The outlets of the nozzles 125b and 125c are directed toward the rails 44a and 44b, the carrier body 74, and the guide rollers 76 to 79. The jet gas cleaning area 83 is provided with a nitrogen gas supplying section 127. The nitrogen gas supplying section 127 is connected to the nozzles 125a to 125c.

To perform jet gas cleaning, the nitrogen gas is supplied from the nitrogen gas supplying section 127 to the nozzles 125a to 125c. Nitrogen gas is blown from the outlet of the nozzle 125a onto the pins 72 and the pin plate 73, and from the outlets of the nozzles 125b and 125c onto the rails 44a and 44b, the carrier body 74, and the guide rollers 76 to 79.

The residual water content and the residual foreign substances on the pins 72 and the pin plate 73 after the steam cleaning are blown off with the nitrogen gas. It is preferable that a flow rate of the nitrogen gas is not less than 10 m/min.

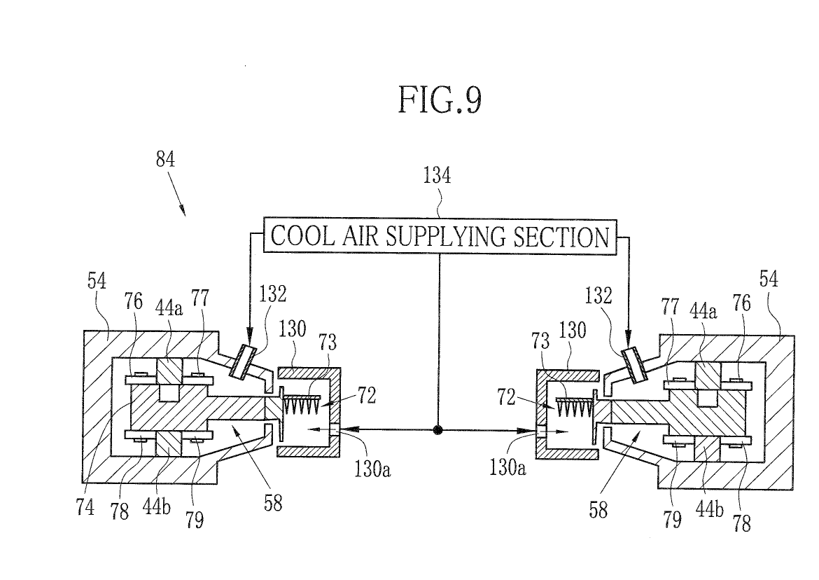

As shown in FIG. 9, the first cooling area 84 is provided with a pair of pin covers 130. Each pin cover 130 covers the pins 72 and the pin plates 73 of the pin carriers 58 on each rail 44. A supply slit 130a is formed through each of opposing surfaces of the pin covers 130. In the first cooling area 84, a nozzle 132 is connected to each rail cover 54. An outlet of the nozzle 132 is directed to the inside of the rail cover 54. The first cooling area 84 is provided with a cool air supplying section 134. The cool air supplying section 134 is connected to the supply slit 130a.

In the first cooling area 84, the cool air supplying section 134 supplies cool air to keep the overall temperature of the inside of the rail cover 54 and the inside of the pin cover 130 approximately constant. The cool air is at a predetermined temperature of, for example, not less than −30° C. and not more than 30° C. Thereby, the overall temperature of the inside of the rail cover 54 and the inside of the pin cover 130 becomes not more than the melting point of TPP, that is, 50° C. The temperature of the pin carriers 58 and the rails 44a and 44b are regarded as approximately the same as the above overall temperature. If TPP and the like evaporated together with the solvent vapors from the wet film 25 enter the first cooling area 84 in accordance with movement of the pin carriers 58, such TPP and the like will be precipitated on the pin carriers 58 and the rails 44a and 44b.

In the second cooling area 86, only the pins 72 and the pin plates 73 are cooled by cool air. The second cooling area 86 is similar to the first cooling area 84 except that the pin covers 130 are not used in the second cooling area 86, so descriptions on a configuration of the second cooling area 86 are omitted. Cooling of the pins 72 and the pin plates 73 is advanced in the second cooling area 86, and the surface temperatures of the pins 72 and the pin plates 73 reach not less than 35° C. and not more than 50° C. Thereby, piercing of the pins 72 through the edges 25a is facilitated.

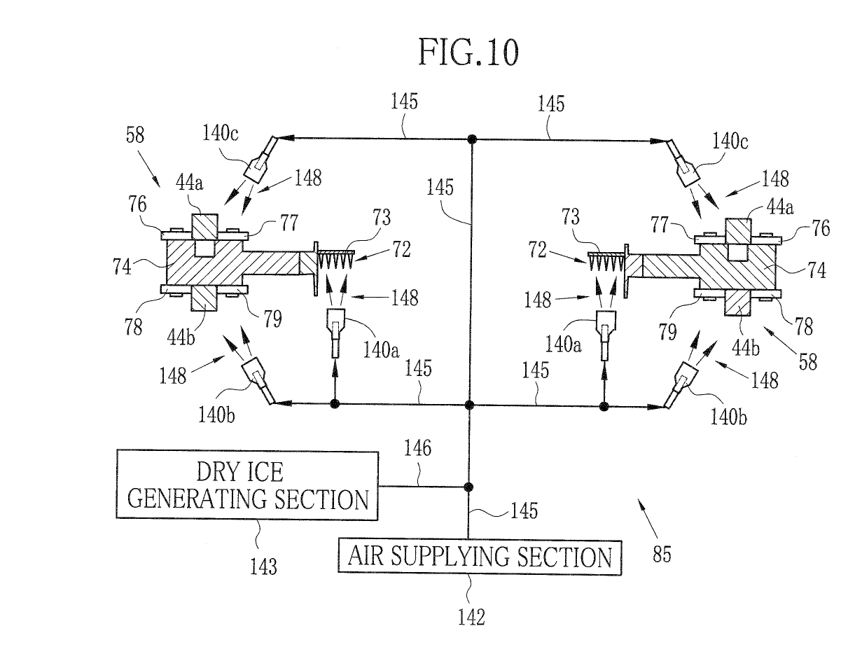

As shown in FIG. 10, the dry ice cleaning area 85 is provided with nozzles 140a to 140c. Dry ice particles are blown through the nozzles 140a to 140c. An outlet of the nozzle 140a is directed toward the pins 72 and the pin plates 73. The outlets of the nozzles 140b and 140c are directed to the rails 44a and 44b, the carrier body 74, and the guide rollers 76 to 79. The dry ice cleaning area 85 is provided with an air supplying section 142 and a dry ice generating section 143. The air supplying section 142 is connected to the nozzles 140a to 140c through a pipe 145. The dry ice generating section 143 is connected to the pipe 145 through a pipe 146.

To perform dry ice cleaning, the air supplying section 142 supplies air to the pipe 145. The dry ice particles are generated in the dry ice generating section 143. The dry ice particles are mixed into air in the pipe 145 through the pipe 146. Mixed air 148, with which air and dry ice particles are mixed, is blown onto the pins 72 and the pin plates 73 through the nozzle 140a, and onto the rails 44a and 44b, the carrier body 74, and the guide rollers 76 to 79 through the nozzles 140b and 140c. Instead of using the dry ice generating section 143, dry ice may be generated in a nozzle capable of introducing CO₂ gas and compressed air therein and generating dry ice particles.

When the mixed air 148 is blown, the dry ice particles impinge against the foreign substances adhered to pins 72, the pin plates 73, the rails 44a and 44b, the carrier body 74, and the guide rollers 76 to 79. The foreign substances are crushed by the impingement and removed. The removed foreign substances are entrained in the mixed air 148 and collected by a dust collector (not shown).

In this embodiment, the foreign substances are removed by blowing the mixed air 148 containing the dry ice particles. However, it is not limited to the dry ice particles as long as the particles sublime after impingement against the foreign substances. It is not limited to use air for blowing the dry ice particles. Instead, inert gas such as nitrogen gas may be used.

Layouts and the number of the nozzles 90, 120a to 120c, 125a to 125c, 132, 140a to 140c, and the vent pipe 91 are not limited to those shown in the figures, and may be changed as necessary.

In this embodiment, the wet film 25 is conveyed without reversing it after the edges 25a are held and before the edges 25a are released. However, a way of conveying the wet film is not limited. The wet film may be conveyed by a multistage conveying method by which the wet film is reversed for several times.

In this embodiment, nitrogen gas is used in the gas purge area 81 and the jet gas cleaning area 83. Instead of nitrogen gas, other inert gas may be used. It is also possible to use air instead of nitrogen gas. In this case, it is preferable that concentration of the plasticizers and the UV absorbents contained in the air is not more than 100 ppb. It is more preferable that the above concentration is not more than 10 ppb. It is most preferable that the above concentration is not more than 1 ppb.

In this embodiment, the pins, the pin plates, the guide rollers, and the like are cleaned. In addition, it is also possible to clean the teeth of the sprockets. By cleaning the teeth of the sprockets, the fitting of the teeth of the sprockets and the fitting grooves of the pin carrier is improved. Accordingly, the pin carriers are moved more stably. Foreign substances adhered to the sprockets are removed by cleaning so that the film is not contaminated by the contact with the sprockets.

In this embodiment, foreign substances are removed by four kinds of cleaning, namely, the gas purge, the jet gas cleaning by blowing nitrogen gas, the steam cleaning by blowing steam, and the dry ice cleaning by blowing mixed air with which dry ice particles are mixed. It is not necessary to perform all the above four kinds of cleaning. Cleaning other than the gas purge may be selected as necessary. For example, a combination of the gas purge and one of the above three kinds of cleaning other than the gas purge, or a combination of the gas purge and two of the above three kinds of cleaning other than the gas purge may be performed. The gas purge may be constantly performed, and the above three kinds of cleaning other than the gas purge may be performed intermittently as necessary. To perform the intermittent cleaning, the above three kinds of cleaning may be performed simultaneously, or each kind of cleaning may be performed sequentially.

In this embodiment, the pin tenter 13 of the present invention is introduced in the film producing line 10. However, the producing line is not limited to the above. The pin tenter may be installed in other producing lines such as a web producing line which produces a web. In this embodiment, the present invention is applied to the pin tenter. However, it is not limited to the above. The present invention may also be applied to a clip tenter. In this case, a carrier body having clips constitute an endless loop moving section.

It is preferable that the width of the film 37 produced in the above embodiment is not less than 1400 mm and not more than 2500 mm. The present invention is also effective in the case the width of the film 37 exceeds 2500 mm. It is preferable that the thickness of the film 37 produced in the above embodiment is not less than 20 μm and not more than 100 μm. It is more preferable that the thickness of the film 37 is not less than 20 μm and not more than 80 μm. It is most preferable that the thickness of the film 37 is not less than 30 μm and not more than 70 μm.

In the above embodiment, a single layer film is produced from one kind of dope. The present invention is also effective in producing a casting film with a multilayer structure. In this case, any known method is used for casting a desired number of dopes simultaneously or sequentially and the method to be used is not particularly limited. Paragraphs from [0617] to [0889] of Japanese Patent Laid-Open Publication No. 2005-104148 describe in detail the structures of the casting die, the decompression chamber and the support, co-casting, peeling, stretching, drying condition in each process, handling methods, curling, winding methods after the correction of planarity, recovering methods of the solvent, and recovering methods of a film. The above descriptions may be applied to the present invention. Performance of the produced film, degrees of curling, thickness, and measuring methods thereof are disclosed in paragraphs from [1073] to [1087] of Japanese Patent Laid-Open Publication No. 2005-104148. The above descriptions may be applied to the present invention.

It is preferable to perform surface treatment to at least one of the surfaces of the produced film so as to improve adhesion property of the produced film to optical parts of, for example, a polarizing filter. It is preferable to perform at least one of the following treatments as the surface treatment: for example, vacuum glow discharge, plasma discharge under the atmospheric pressure, UV-ray irradiation, corona discharge, flame treatment, acid treatment and alkali treatment.

The produced film 37 may be used as a functional film by providing a desired functional layer to at least one of the surfaces. Examples of the functional layer are an antistatic layer, a curable resin layer, an anti-reflection layer, an easy-adhesion layer, an anti-glare layer, optical compensation layer and the like. For example, an anti-reflection film is produced by providing the anti-reflection layer to the produced film 37. The anti-reflection film prevents reflection of light and serves to achieve high image quality. The above described functional layers for imparting various functions to the film and forming methods thereof are detailed in paragraphs [0890] to [1072] of Japanese Patent Laid-Open Publication No. 2005-104148. These descriptions may be applied to the present invention. Specifically, the polymer film is used in TN type, STN type, VA type, OCB type, reflection type, and other types of the LCD devices, detailed in Japanese Patent Laid-Open Publication No. 2005-104148.

Next, raw materials of the dope produced in the dope producing line 20 are described in the following.

It is preferable to use cellulose ester as the raw material of the dope so as to produce the film with high degree of transparency. Cellulose ester contained in the dope is, for example, lower fatty acid ester of cellulose, such as cellulose triacetate, cellulose acetate propionate, and cellulose acylate butyrate. In order to form a film with excellent optical transparency, cellulose acylate is preferable, and triacetyl cellulose (TAC) is especially preferable. The dope used in the above embodiment contains TAC as the polymer. It is preferable to use TAC particles at least 90 wt. % of which have the diameter of 0.1 mm to 4 mm.

It is preferable that a degree of substitution of hydroxyl group for acyl group in cellulose acylate preferably satisfies all of the following mathematical expressions (e)-(c) so as to produce a film with a high degree of transparency.

2.5≦A+B≦3.0 (a)

0≦A≦3.0 (b)

0≦B≦2.9 (c)

In these mathematical expressions (a) to (c), A is the degree of substitution of the hydrogen atom of the hydroxyl group for the acetyl group, and B is a degree of substitution of the hydrogen atom of the hydroxyl group for the acyl group with 3 to 22 carbon atoms.

The cellulose is constructed of glucose units making β-1,4 combination, and each glucose unit has a free hydroxyl group at second, third and sixth positions. Cellulose acylate is a polymer in which a part of or the entire of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl group at the same position are substituted, the degree of substitution at this position is 1.

When the degrees of substitution of the acyl groups for the hydroxyl group at the second, third or sixth positions per glucose unit are respectively described as DS2, DS3 and DS6, the total degree of substitution of the acyl groups for the hydroxyl group at the second, third and sixth positions (namely DS2+DS3+DS6) is preferably in the range of 2.00 to 3.00, more preferably in the range of 2.22 to 2.90. It is especially preferable that DS2+DS3+DS6 is in the range of 2.40 to 2.88. In addition, DS6/(DS2+DS3+DS6) is preferably at least 0.28, and more preferably 0.30. It is especially preferable that DS6/(DS2+DS3+DS6) is in the range of 0.31 to 0.34.

One or more sorts of acyl group may be contained in the cellulose acylate. When two or more sorts of the acyl groups are used, it is preferable that one of them is acetyl group. If the total degree of substitution of the acetyl groups for the hydroxyl group and that of acyl groups other than the acetyl group for the hydroxyl group at the second, third or sixth positions are respectively described as DSA and DSB, it is preferable that the value DSA+DSB is in the range of 2.22 to 2.90. It is especially preferable that the value DSA+DSB is in the range of 2.40 to 2.88.

It is preferred that the DSB is at least 0.30, and especially preferred that the DSB is at least 0.7. Further, the percentage of the substituent for the hydroxyl group at the sixth position in DSB is preferred to be at least 20%, more preferred to be at least 25%, further more preferred to be at least 30%, and especially preferred to be at least 33%. Further, a value DSA+DSB at the sixth position of cellulose acylate is preferred to be at least 0.75, more preferred to be at least 0.80, and especially preferred to be at least 0.85. A dope having excellent solubility is prepared using cellulose acylate satisfying the above conditions. Especially when non-chlorine type solvent is used with the above-described cellulose acylate, a dope having excellent solubility, low viscosity, and excellent filterability is prepared.

Cellulose, which is a raw material of cellulose acylate, may be produced from cotton linter or pulp.

Acyl group, of cellulose acylate, having at least 2 carbon atoms maybe aliphatic group or aryl group, and is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

The cellulose acylate usable in the present invention are detailed in paragraphs [0140] to [0195] in Japanese Patent Laid-Open Publication No. 2005-104148. These descriptions may be applied to the present invention.

The solvent, which is one of the raw materials of the dope, is preferred to be an organic compound capable of dissolving polymer. In the present invention, a dope is a mixture produced by dissolving or dispersing polymer in a solvent. Therefore, solvents having low solubility for polymer may also be used. Preferable solvent compounds for preparing the dope are, for example, aromatic hydrocarbon (for example, benzene, toluene and the like), halogenated hydrocarbons (for example, dichloromethane, chloroform, chlorobenzene and the like), alcohols (forexamplemethanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. A mixed solvent, in which two or more kinds of the above solvent compounds are mixed, may also be used. Among the above solvent compounds, dichloromethane is preferable. With the use of dichloromethane, the dope with excellent solubility is produced, and the solvents contained in the casting film are evaporated in a short time to form a film.

Among the above halogenated hydrocarbons, those having 1 to 7 carbon atoms are preferable. In view of physical properties such as solubility of TAC, peelability (which is an index indicating ease of peeling) of a casting film from a support, mechanical strength and optical properties of the film, it is preferable to use at least one sort of the alcohols having 1 to 5 carbon atoms with dichloromethane. The content of the alcohols is preferably in the range of 2 wt. % to 25 wt. %, and more preferably in the range of 5 wt. % to 20 wt. % to the total solvent compounds in the solvent. Specific examples of the alcohols are methanol, ethanol, n-propanol, isopropanol, n-butanol, and the like. It is preferable to use methanol, ethanol, n-butanol or a mixture thereof.

In order to minimize the influence on the environment, the dope may be prepared without dichloromethane. In this case, the solvent containing ethers with 4 to 12 carbon atoms, ketones with 3 to 12 carbon atoms, esters with 3 to 12 carbon atoms, or a mixture of them may be used. The ethers, ketones, and esters may have cyclic structures. At least one solvent compound having at least two functional groups thereof (—O—, —CO—, and —COO—) may be contained in the organic solvent. The solvent may contain other functional group such as alcoholic hydroxyl group. In the case the solvent compound contains two or more sorts of functional groups, the number of carbons is not particularly limited as long as it is within a specified limit of a compound having any one of the functional group.

Well-known additives such as plasticizers, UV absorbents, deterioration inhibitors, lubricating agents, and peeling improvers may be added to the dope as necessary. Well-known plasticizers may be used, for example, phosphoric acid ester plasticizers such as triphenyl phosphate and biphenyl diphenyl phosphate, phthalic acid ester plasticizers such as diethyl phthalate, and polyester polyurethane elastomer and the like.

It is preferable to add fine particles to the dope so as to adjust a refractive index of the film and prevent adhesion of the films. It is preferable to use silicon dioxide derivatives as the fine particles. The term “silicon dioxide derivatives” of the present invention includes silicon dioxide and silicone resin having three-dimensional network structures. The silicon dioxide derivatives with the alkylated surfaces are preferable. Hydrophobized particles such as alkylated particles are well dispersed in the solvent. As a result, the dope is prepared and the film is produced without coagulation of the fine particles. Thereby, the film with a high degree of transparency and few surface defects is produced.

As an example of the above-described fine particles with the alkylated surfaces, commercially available Aerosil R805 (produced by Degussa Japan, Co. Ltd.), which is a silicon dioxide derivative introduced with octyl group on the surface, or the like may be used. In order to produce the film with a high degree of transparency while the effectiveness of the fine particles is ensured, the content of the fine particles with respect to the solid content of the dope is preferably not more than 0.2%. In addition, In order to prevent the fine particles from interfering with light, the average particle diameter is preferably not more than 1.0 μm and more preferably 0.3 μm to 1.0 μm, and most preferably 0.4 μm to 0.8 μm.

As described above, it is preferable to use TAC to produce cellulose ester film having excellent optical transparency. In this case, a ratio of TAC is preferably 5 wt. % to 40 wt. % with respect to a total amount of the dope mixed with solvents and additives, and more preferably 15 wt. % to 30 wt. %. It is especially preferable that the ratio of TAC is 17 wt. % to 25 wt. %. A ratio of the additives (mainly plasticizers) is preferably 1 wt. % to 20 wt. % with respect to the whole solid content including polymer and other additives contained in the dope.

Solvents, additives such as plasticizers, UV absorbents, deterioration inhibitors, lubricating agents, peeling improvers, optical anisotropy controllers, retardation controllers, dyes, and peeling agents, and fine particles are detailed in paragraphs [0196] to [0516] of Japanese Patent Publication No. 2005-104148. These descriptions may be applied to the present invention. In addition, producing methods of a dope using TAC including, for example, materials, raw materials, dissolution methods and adding methods of additives, filtering methods, and defoaming are disclosed in paragraphs [0517] to [0616] of Japanese Patent Laid-Open Publication No. 2005-104148. These descriptions may be applied to the present invention.

### EXAMPLE

The film 37 was produced using the film producing line 10 shown in FIG. 1. An appropriate amount of the dope was fed from the dope producing line 20 to the casting die 23 through the feed block 21. The dope was cast from the casting die 23 onto the drum 22 which was rotated continuously. Thus the casting film 24 was formed. The discharge port of the casting die 23 was a slit having a width of 1.8 m. The temperature of the dope at the casting was 36° C. The inner temperature of the feed block 21 was 36° C. The pressure of the decompression chamber 32 was set at 600 Pa and the pressure of the area upstream from the bead with respect to the rotation direction of the drum 22 was reduced.

The drum 22 was a stainless steel drum capable of controlling the number of rotations. A coolant was supplied from a heat transfer medium supplying device (not shown) to the inside of the drum 22. Thus, the surface temperature of the drum 22 was adjusted at −10° C. The inner temperature of the casting chamber 11 was constantly kept at 35° C. using the temperature controller 30.

The casting film 24 was cooled and gelated. When the casting film 24 obtained the self-supporting property, the casting film 24 was peeled off as the wet film 25 using the peel roller 26. Thereafter, the wet film 25 was sent to the transfer section 12. The wet film 25 was conveyed through the transfer section 12 while being conveyed by the plurality of rollers 35. During the conveyance, the dry air adjusted at 40° C. was supplied from the air blower 36 to the transfer section 12, and the film 37 was dried.

As shown in FIG. 2, the edges 25a of the wet film 25 were pierced and held by the pins 72 (see FIG. 4). In this state, the wet film 25 was conveyed. As shown in FIG. 3, the dry air duct 52 was provided above and along the conveying path of the wet film 25, and the dry air duct 53 was provided below and along the conveying path of the wet film 25. In the first cooling area 84, the pin carrier 58, the pins 72, and the pin plate 73 were cooled by cool air. In the second cooling area 86, the pins 72 and the pin plate 73 were cooled by cool air.

As shown in FIG. 1, the wet film 25 was sent from the pin tenter 13 to the clip tenter 14. In the clip tenter 14, the wet film 25 was conveyed while edges 25a were held. The wet film 25 was dried while being conveyed. Thus, the film 37 was produced. The edges 25 of the film 37 were cut along the lines, each of which was 50 mm inside from the both side edges of the film 37, using the edge slitting device 15. The edge slitting device 15 had an NT cutter disposed at a position where the front end of the film 37 reaches within 30 seconds from the exit of the clip tenter 14. The cut-off edges of the film 37 were sent to the crusher 66 using a cutter blower (not shown). The cut-off edges were crushed into chips of approximately 80 mm² in average.

A preheating chamber (not shown) was provided between the edge slitting device 15 and the drying device 16. The film 37 was preheated by supplying dry air at 100° C. to the preheating chamber. Thereafter, the film 37 was sent to the drying device 16. In the drying device 16, the film 37 was conveyed while being bridged across the plurality of rollers 67. The film 37 was dried while being conveyed. The inner temperature of the drying device 16 was adjusted to make the surface temperature of the film 37 140° C. The drying time of the film 37 in the drying device 16 was 10 minutes. The surface temperature of the film 37 was measured using a thermometer (not shown) provided at a position directly above and in close proximity to the conveying path of the film 37. In the drying device 16, solvent vapors evaporated from the film 37 were recovered using the recovery device 69. The recovery device 69 had an adsorbing agent, which was activated carbon, and desorbing agent, which was dry nitrogen. After the solvent vapors were recovered, a water content in the solvent vapors was removed to be not more than 0.3 wt. %.

A moisture control chamber (not shown) was provided between the drying device 16 and the cooling device 17. Air at the temperature of 50° C. and dew point of 20° C. was supplied to the film 37. Thereafter, air at 90° C. and humidity of 70% was directly blown onto the film 37 to smooth the curls in the film 37. Next, the film 37 was sent to the cooling device 17. The film 37 was gradually cooled until the temperature becomes not more than 30° C.

The film 37 was sent to the winding device 18. The film 37 was wound around the winding shaft 70 while 50 N/m of pressure was applied to the film 37 using the press roller 71. The diameter of the winding shaft 70 was 169 mm. A tension at the start of winding was 300 N/m. A tension at the end of winding was 200 N/m. Thus, the film 37 was wound in a roll form.

The width of the produced film 37 was 1700 mm. The thickness of the produced film 37 was 80 μm. Average drying speed of the casting film 24 and the film 37 were 20 wt. %/min throughout the film producing process.

Four compositions of the raw materials of the dope used in the embodiment are described as follows.

[Composition 1]

| | | |
|---|---|---|
| Methylene chloride | 83.5 | pts. wt. |
| Methanol | 16 | pts. wt. |
| Butanol | 0.5 | pts. wt. |
| Water (outer percentage) | 0.2 to 1.0 | pts. wt. |

[Composition 2]

| | | |
|---|---|---|
| Methylene chloride | 84.5 | pts. wt. |
| Methanol | 13.5 | pts. wt. |
| Butanol | 2 | pts. wt. |
| Water (outer percentage) | 0.2 to 1.0 | pts. wt. |

[Composition 3]

| | | |
|---|---|---|
| Methylene chloride | 85 | pts. wt. |
| Methanol | 12 | pts. wt. |
| Butanol | 3 | pts. wt. |
| Water (outer percentage) | 0.2 to 1.0 | pts. wt. |

[Composition 4]

| | | |
|---|---|---|
| Methylene chloride | 92 | pts. wt. |
| Methanol | 8 | pts. wt. |
| Butanol | 0 | pts. wt. |
| Water (outer percentage) | 0.2 to 1.0 | pts. wt. |

In addition, the following materials were added to each of the above Compositions 1 to 4.

| | | |
|---|---|---|
| TAC | 100 | pts. wt. |
| Plasticizer A | 7.6 | pts. wt. |
| Plasticizer B | 3.8 | pts. wt. |
| UV absorbent a | 0.7 | pts. wt. |
| UV absorbent b | 0.3 | pts. wt. |
| Citric acid ester mixture | 0.006 | pts. wt. |
| Fine particles | 0.05 | pts. wt. |

The above TAC was powder satisfying the following conditions: the degree of substitution was 2.84, the viscometric average degree of polymerization was 306, the water content was 0.2 wt. %/the viscosity of 6 wt. % of dichloromethane solution was 315 mPa·s, the average particle diameter was 1.5 mm, and the standard deviation of the average particle diameter was 0.5 mm. The plasticizer “A” was triphenylphosphate. The plasticizer “B” was diphenyl phosphate. The UV absorbent “a” was 2-(2′-hydroxy-3′,5′-di-tert-butylphenyl) benzotriazol and UV absorbent “b” was 2-(2′-hydroxy-3′,5′-di-tert-amylphenyl)-5-chlorobenzotriazol. The citric acid ester mixture was a mixture of citric acid, citric acid monoethyl ester, citric acid diethyl ester and citric acid triethyl ester. Fine particles were silicon dioxide with average particle diameter of 15 nm and Mohs hardness of approximately 7. At the preparation of the dope, a retardation controller (N-N′-di-m-tolyl-N″-p-methoxyphenyl-1,3,5-triazine-2,4,6-triamine) was added such that the amount of the retardation controller represented 4.0 wt. % of the total amount of the produced film 37.

Next, the pins 72, the pin plate 73, and the like in the pin tenter 13 were cleaned, as described in Examples 1 to 4, Comparative example 1, and Reference examples 1 and 2 (see Table

### Example 1

In the gas purge area 81, nitrogen gas was purged from the inside of the rail covers 54 and 55 (hereinafter referred to as gas purge).

### Example 2

In addition to the gas purge, steam was blown onto the pins 72, the pin plate 73, the rails 44a and 44b, the carrier body 74, and the guide rollers 76 to 79 through the nozzles 120a to 120c in the steam cleaning area 82 (hereinafter referred to as steam cleaning).

### Example 3

In addition to the gas purge and the steam cleaning, nitrogen gas was blown onto the pins 72, the pin plate 73, the carrier body 74, the rails 44a and 44b, and the guide rollers 76 to 79 (hereinafter referred to as jet gas cleaning) in the jet gas cleaning area 83.

### Example 4

In addition to the gas purge, the steam cleaning, and the jet gas cleaning, the mixed air 148 with which dry ice particles are mixed was blown on to the pins 72, the pin plate 73, the carrier body 74, the rails 44a and 44b, and the guide rollers 76 to 79 in the dry ice cleaning area 85 (hereinafter referred to as dry ice cleaning).

### Example 5

Only the gas purge and the dry ice cleaning were performed.

### Comparative Example

None of the jet gas cleaning, the steam cleaning, the gas purge, and the dry ice cleaning were performed to the pins 72, the pin plate 73, the carrier body 74, the rails 44a and 44b, and the guide rollers 76 to 79.

### Reference Example

Only the dry ice cleaning was performed.

The results of the above Examples 1 to 5, the Comparative example, and the Reference example are shown in Table 1. In the Table 1, E1 to E5 denote the Examples 1 to 5. CE denotes the Comparative example. RE denotes the Reference example. “Steam” denotes the steam cleaning. “Jet gas” denotes the jet gas cleaning. “Dry ice” denotes the dry ice cleaning. “Y” denotes that the gas purge or the cleaning was performed. “N” denotes that the gas purge or the cleaning was not performed.

TABLE 1

| | | | | | Pin | Guide |
|---|---|---|---|---|---|---|
| | | | | | plate | roller |
| | Gas | | Jet | Dry | cleaning | cleaning |
| | purge | Steam | gas | ice | effect | effect |
| E1 | Y | N | N | N | E | D |
| E2 | Y | Y | N | N | C | A |
| E3 | Y | Y | Y | N | B | A |
| E4 | Y | Y | Y | Y | A | A |
| E5 | Y | N | N | Y | C | A |
| CE | N | N | N | N | E | E |
| RE | N | N | N | Y | C | C |

In the Table 1, the pin plate cleaning effect denotes to what extent the foreign substances adhered to the pin plates 73 were removed. The guide roller cleaning effect denotes to what extent the foreign substances adhered to the guide rollers 76 to 79 were removed. In the evaluation of effects, “A” denotes that the foreign substances were completely removed, and the pin plate 73 or the guide rollers 76 to 79 remained maintenance-free for more than one and a half years. “B” denotes that the foreign substances were removed to the extent that the pin plates 73 or the guide rollers 76 to 79 remained maintenance-free for more than one and a half years, “C” denotes that the foreign substances were removed to the extent that the pin plates 73 or the guide rollers 76 to 79 remained maintenance-free for more than one year and not more than one and a half years. “D” denotes that the foreign substances were removed to the extent that the pin plates 73 or the guide rollers 76 to 79 remained maintenance-free for more than half a year and not more than one year. “E” denotes that the foreign substances were removed to the extent that the pin plates 73 or the guide rollers 76 to 79 remained maintenance-free for not more than half a year. In the examples, those remained maintenance free for more than half a year is judged effective. The results of the example 1 show that the foreign substances adhered to the pin plate 73 were not effectively removed only by the gas purge, but the gas purge has the effect of removing the foreign substances adhered to the guide rollers 76 to 79.

The cleaning effect is improved by performing the jet gas cleaning and the steam cleaning in addition to the gas purge. Especially, the foreign substances are completely removed by adding the gas purge. As is evident from the Reference example, the dry ice cleaning alone is as effective as the jet gas cleaning.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method for drying a film comprising the steps of:
drying said film by blowing dry air onto said film while said film being conveyed using a pair of endless loop moving sections in a state that side edge portions of said film being held by holding members, each of said endless loop moving sections being provided with a carrier body having said holding members arranged at predetermined intervals; and
supplying inert gas to a duct and purging said inert gas from said duct, said duct covering said carrier body in an area where said film being held by said holding members.

2. The method of claim 1, wherein a supply position and a recovery position of said inert gas on said duct are in the proximity of a film release position where said film is released from said holding members.

3. The method of claim 1, further including the step of:
cleaning said holding members and said carrier body by blowing steam onto said holding members and said carrier body after said film being released from said holding members.

4. The method of claim 3, further including the step of:
cleaning said holding members and said carrier body by blowing gas onto said holding members and said carrier body after said cleaning step.

5. A solution casting method comprising the steps of:
forming a casting film by casting a dope containing a polymer and a solvent onto a continuously moving support;
peeling said casting film from said support as a wet film;
drying said wet film by blowing dry air onto said wet film while said wet film being conveyed using a pair of endless loop moving sections in a state that side edge portions of said wet film being held by holding members, each of said endless loop moving sections being provided with a carrier body having said holding members arranged at predetermined intervals; and
supplying inert gas to a duct and purging said inert gas from said duct, said duct covering said carrier body in an area where said film being held by said holding members.

6. A film drying apparatus comprising:
a pair of endless loop moving sections for conveying a film, each of said endless loop moving sections being provided with a carrier body having holding members for holding side edge portions of said film, said holding members being arranged at predetermined intervals on said carrier body;
a drying section for drying said film by blowing dry air onto said film, said film being held and conveyed by said holding members; and
a gas purge section for supplying inert gas to a duct and purging said inert gas from said duct, said duct covering said carrier body in an area where said film being held by said holding members.

7. The film drying apparatus of claim 6, said gas purge section including:
an inert gas supplying section for supplying inert gas to said duct and purging said inert gas from said duct, and
an inert gas circulating section for recovering said inert gas from said duct and feeding said recovered inert gas to said inert gas supplying section, said duct being kept in a pressurized state by said inert gas supplying section.

8. The film drying apparatus of claim 7, wherein a supply position and a recovery position of said inert gas on said duct are located immediately after a film release position where said film is released from said holding members.

9. The film drying apparatus of claim 6, further including a steam cleaning section for cleaning said holding members arid said carrier body by blowing steam onto said holding members and said carrier body.

10. The film drying apparatus of claim 9, further including a gas-blow cleaning section for cleaning said holding members and said carrier body by blowing gas onto said holding members and said carrier body after said film being released from said holding members, said gas-blow cleaning section being provided downstream from said steam cleaning section with respect to a moving direction of said carrier body.
